(19) United States
(12) Patent Application Publication
(10) Pub. No.: US 2009/0146926 A1
(43) Pub. Date: Jun. 11, 2009

(54) DRIVING APPARATUS AND DRIVING METHOD FOR AN ORGANIC LIGHT EMITTING DEVICE

(76) Inventors: Si-Duk SUNG, Seoul (KR); Baek-Woon Lee, Yongin-si (KR)

Correspondence Address: Haynes and Boone, LLP;IP Section, 2323 Victory Avenue, SUITE 700, Dallas, TX, 75219, US

(21) Appl. No.: 12/234,577

(22) Filed: Sep. 19, 2008

(30) Foreign Application Priority Data
Dec. 5, 2007 (KR) 10-2007-0125411

(51) Int. Cl. G09G 3/30

(52) U.S. Cl. 345/76

(57) ABSTRACT

A driving apparatus for an organic light emitting device including pixels with light-emitting devices and a method of making such apparatus are presented. The uniform values based on voltages for each frame corresponding to grays of input image signals are calculated and summed, and data voltages are increased when the sum exceeds a predetermined value. The apparatus helps maintain the desired brightness in an organic light emitting diode (OLED) display device through the lifespan of the device.

### CROSS-REFERENCE TO RELATED APPLICATION

This application claims priority to and the benefit of Korean Patent Application No. 10-2007-0125411 filed in the Korean Intellectual Property Office on Dec. 5, 2007, the entire contents of which are incorporated herein by reference.

### BACKGROUND OF THE INVENTION

1. Field of the Invention

The present invention relates to a driving apparatus for an organic light emitting device and a driving method thereof.

2. Description of the Related Art

Recent trends toward lightweight and thin personal computers and television sets may require lightweight and thin display devices. Flat panel displays satisfying such requirements are being substituted for conventional cathode ray tubes (CRTs).

A flat panel display may include a field emission display (FED), a plasma display panel (PDP), a liquid crystal display (LCD), or other suitable display.

In general, in an active type of flat panel display, a plurality of pixels are arranged in a matrix form, and images are displayed by controlling the light strength of each pixel according to given brightness information. For example, an organic light emitting diode (OLED) display is a display device that displays an image by electrically exciting a fluorescent organic material to emit light. The OLED display is a self-light-emitting type and has low power consumption and a rapid response speed of pixels. Furthermore, it can easily display a motion picture with a high image quality.

The OLED display includes an OLED and a thin film transistor (TFT) for driving the OLED.

In the organic light emitting device, the brightness is changed by controlling the amount of current that flows in the organic light emitting diode. After some time has passed, the voltage of the output terminal of the driving transistor may be increased such that the current is decreased. As a result, the current that flows in the organic light emitting diode decreases. Accordingly, this generates a problem in which the desired brightness may be not displayed, thereby decreasing the lifetime of the organic light emitting device.

The above information disclosed in this Background section is only for enhancement of understanding of the background of the invention and therefore it may contain information that does not form the prior art that is already known in this country to a person of ordinary skill in the art.

### SUMMARY OF THE INVENTION

Accordingly, the present invention is to provide a driving apparatus for an organic light emitting device and a driving method thereof to extend the lifespan of an organic light emitting device.

The technical objects of the present invention are not limited by the above-described technical objects, and other technical objects that are not mentioned may be comprehended in detail from the following description by a person of ordinary skill in the art.

In one aspect, the invention is a driving apparatus for an organic light emitting device having pixels with a light-emitting device. The apparatus includes uniform values based on voltages for each frame corresponding to grays of input image signals. These uniform values are calculated and summed, and data voltages are increased when the sum exceeds a predetermined value.

In an example embodiment, the driving apparatus may include an expansion unit receiving first image signals and expanding the number of grays of first image signals to output second image signals, a compression unit compressing the number of grays of the second image signals and the corresponding voltages to generate third image signals, a calculator calculating the voltages corresponding to the grays of the first image signal to calculate uniform values, an accumulator summing the uniform values, a memory sequentially increasing bits according to the output signals from the accumulator, an adder adding the third image signals from the compression unit and the signals from the memory to generate fourth image signals, and a reduction unit reducing the number of grays of the fourth image signals to generate fifth image signals.

The expansion unit and reduction unit may execute the expansion and reduction while maintaining the previous voltage.

The calculator may add all the voltages corresponding to one frame, and output uniform values according to a lower value and an upper value for the added voltage values.

The accumulator may generate a sum of the uniform values and output an output signal when the sum exceeds the predetermined value.

The grays of the first and second image signals may have a voltage of a predetermined range, the voltage range of the grays of the third image signals may be less than the voltage range of the grays of the first and second image signals, and the grays of the fourth and fifth image signals may be equal to or more than the voltage range of the grays of the third image signals.

The grays of the first to fifth image signals and the corresponding voltages may be determined as a linear function.

The memory may be a non-volatile memory.

When the number of bits of the memory is increased by 1 bit, the fourth and fifth image signals may be increased by a voltage determined by dividing the voltage range of the grays of the third image signals by the number of compressed grays.

The reduction unit may extract grays among the grays of the fourth image signals with uniform intervals to generate the fifth image signals.

When the number of bits of the memory is increased by 1 bit, the reduction unit may extract grays with uniform intervals among the remaining grays except for the lowest gray among the grays of the fourth image signal to generate the fifth image signals.

The driving apparatus may further include a data driver receiving the fifth image signals and selecting a voltage corresponding to the grays of the fifth image signals as the data voltage to apply to data lines.

In another aspect, the invention is a driving method of an organic light emitting device having pixels with a light-emitting device. The method includes calculating uniform values based on voltages for each frame corresponding to grays of first image signals, generating a sum of the uniform values, expanding the number of grays of the first image signals to generate second image signals, reducing the number of grays of the second image signals along with compression of the corresponding voltages to generate the third image signals, sequentially increasing bits according to a predetermined output signal, adding the third image signals and the increased bits to generate fourth image signals, and reducing the number of grays of the fourth image signals to generate fifth image signals.

The expanding of the number of grays of the first image signals to generate second image signals and the reducing of the number of grays of the fourth image signals to generate fifth image signals may be executed while maintaining the previous voltage.

The calculating of the uniform values based on voltages for each frame corresponding to grays of first image signals may include adding the voltages for each frame and outputting uniform values according to the lower value and the upper value for the added values.

The generating the sum of the uniform values may include outputting an output signal when the sum exceeds the predetermined value.

The grays of the first and second image signals may have a voltage of the predetermined voltage range, the voltage range of the grays of the third image signal may be less than the voltage range of the grays of the first and second image signals, and the voltage range of the grays of the fourth and fifth image signals may be equal to or more than the voltage range of the grays of the third image signal.

The grays and the corresponding voltages of the first to fifth image signals may be determined by a linear function.

When the bits are sequentially increased according to the predetermined output signal, the voltages of the fourth and fifth image signals may be increased by a value determined by dividing the voltage range of the grays of the third image signal by the number of compressed grays.

The reducing of the number of grays of the fourth image signals to generate fifth image signals may include extracting grays among the grays of the fourth image signals with the same interval to generate the fifth image signals.

The reducing of the number of grays of the fourth image signals to generate fifth image signals includes extracting grays with the same interval among the grays of the fourth image signals except for the lowest gray to generate the fifth image signals when the number of bits is sequentially increased.

The driving method may further include receiving the fifth image signals and selecting a voltage corresponding to the grays of the fifth image signals as the data voltage to apply to the pixels.

Accordingly, if the output voltage of the driving transistor is decreased, the data voltage is increased to uniformly maintain the current that flows in the light emitting diode (LED), thereby increasing the lifetime of the organic light emitting device.

### BRIEF DESCRIPTION OF THE DRAWINGS

FIG. 1 is a block diagram of an exemplary embodiment of an organic light emitting device.

FIG. 2 is an equivalent circuit diagram of an exemplary embodiment of one pixel in an organic light emitting device.

FIG. 3 is a block diagram of an exemplary embodiment of the signal controller shown in FIG. 1.

FIG. 4A to FIG. 4E and FIG. 5 are graphs illustrating the operation of the signal controller shown in FIG. 3.

FIG. 6 is a graph illustrating luminance according to time in a conventional organic light emitting device.

FIG. 7 is a flowchart illustrating an exemplary embodiment of a driving method of an organic light emitting device.

### DETAILED DESCRIPTION OF THE EMBODIMENTS

Exemplary embodiments are illustrated and described in the detailed description and drawings.

The advantages, characteristics, and means for achieving the present invention will become apparent from reference to the exemplary embodiments in the following detailed description and the accompanying drawings. However, the present invention is not limited by the hereafter-disclosed exemplary embodiments, and may be modified in various different ways. The present invention is defined by the scope of the claims.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Like reference numerals designate like elements throughout the specification. The term “and/or” includes each of the mentioned items and all combinations of at least one.

The spatially relative terms “below”, “beneath”, “lower”, “above”, and “upper” may be used to easily describe the correlation between one element or constituent elements and another element or constituent elements as shown in the drawings. The spatially relative terms must be comprehended as terms including different directions of the element in addition to the direction shown in the drawings when in use or operation. Like reference numerals designate like elements throughout the specification.

Exemplary embodiments described in this specification will be explained with a layout view, and a cross-sectional view which is an ideal schematic diagram of the present invention. Accordingly, the exemplary views may be changed by a manufacture technique and/or permissible errors. Further, the exemplary embodiments of the present invention are limited by the drawn specific shapes and include changes of the shapes that are generated according to a manufacturing process. The exemplary regions in the drawings include schematic properties, and the shapes of the exemplary regions in the drawings are to indicate the specific shapes of the regions of the element, and not to limit the scope of the invention.

Now, a driving apparatus and a driving method thereof for an organic light emitting device according to an exemplary embodiment of the present invention will be described in detail with reference to the accompanying drawings.

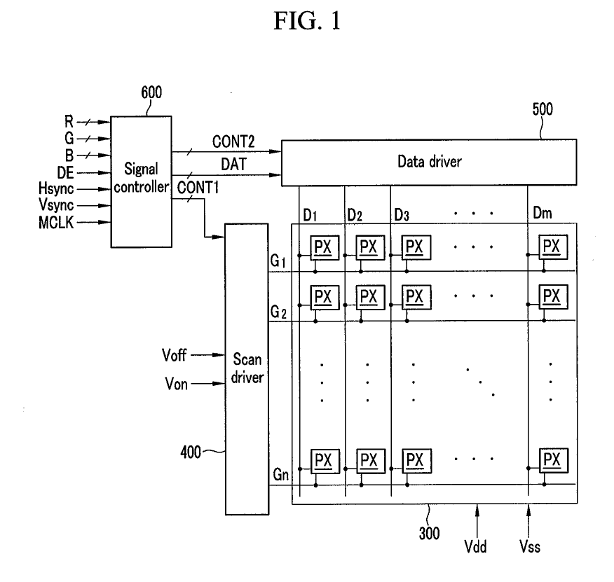

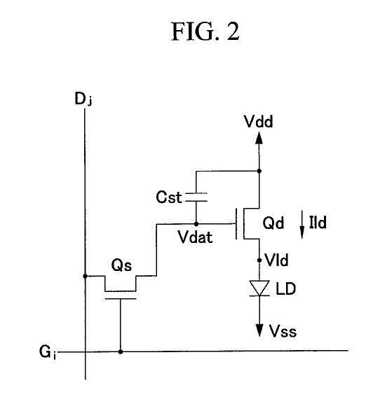

FIG. 1 is a block diagram of an exemplary embodiment of an organic light emitting devic, and FIG. 2 is an equivalent circuit diagram of an exemplary embodiment of one pixel in an organic light emitting device.

As shown in FIG. 1, an exemplary embodiment of an organic light emitting device may include a display panel 300, a scan driver 400, a data driver 500, and a signal controller 600.

Referring to the equivalent circuit diagram in FIG. 2, the display panel assembly 300 may include a plurality of signal lines G₁-Gₙ and D₁-Dₘ, a plurality of driving voltage lines (not shown), and a plurality of pixels PX connected to the signal lines G₁-Gₙ and D₁-Dₘ and arranged substantially in a matrix structure.

The signal lines G₁-Gₙ and D₁-Dₘ may include a plurality of scanning lines G₁-Gₙ transmitting scanning signals, and a plurality of data lines D₁-Dₘ transmitting data signals. The gate lines G₁-Gₙ may extend substantially in a row direction and are substantially parallel to each other. The data lines D₁-Dₘ may extend substantially in a column direction and are substantially parallel to each other.

In an exemplary embodiment, the driving voltage lines may transmit a driving voltage Vdd to each pixel PX.

In an exemplary embodiment, as shown in FIG. 2, each pixel PX of the organic light emitting device, for example a pixel connected to the scanning signal line Gᵢ and the data line Dⱼ, may include an organic light emitting element LD, a driving transistor Qd, a capacitor Cst, and a switching transistor Qs.

The switching transistor Qs may be a three terminal element having a control terminal, an input terminal, and an output terminal. The control terminal of the switching transistor Qs may be connected to the scanning signal line Gᵢ, the input terminal thereof may be connected to the data line Dⱼ, and the output terminal thereof may be connected to the driving transistor Qd. The switching transistor Qs may transmit a data voltage Vdat applied to the data line Dj to the driving transistor Qd in response to a scanning signal applied to the scanning line Gi.

The driving transistor Qd may also be a three terminal element having a control terminal, an input terminal, and an output terminal. The control terminal of the driving transistor Qd may be connected to the switching transistor Qs, the input terminal thereof may be connected to the driving voltage Vdd, and the output terminal thereof may be connected to the organic light emitting diode LD.

The capacitor Cst may be connected between the control terminal and the input terminal of the driving transistor, and may maintain data voltages Vdat applied to the control terminal of the driving transistor Qd.

In an exemplary embodiment, the organic light emitting diode LD as an organic light emitting diode (OLED) may have an anode connected to the output terminal of the driving transistor Qd and a cathode connected to a common voltage Vss. The organic light emitting diode LD may emit light having an intensity depending on an output current lLD of the driving transistor Qd, thereby displaying images. The magnitude of the output current lLD may depend on a voltage difference between the control terminal and the output terminal of the driving transistor Qd, that is to say, a difference between the control terminal voltage Vdat and the output terminal voltage Vld.

The switching transistor Qs and the driving transistor Qd may be n-channel field effect transistors (FETs) including, for example, amorphous silicon or polysilicon. However, at least one of the switching transistor Qs and the driving transistor Qd may be a p-channel FET having an opposite operation to that of the n-channel field effect transistor.

Referring again to FIG. 1, the scan driver 400 may synthesize a high voltage Von and a low voltage Voff for turning on and turning off the switching transistor Qs connected to the scanning signal lines G₁-Gₙ to generate the scanning signals for application to the gate lines G₁-Gₙ.

The data driver 500 may be connected to the data lines D₁-Dₘ, and may apply data signals to the data lines D₁-Dₘ.

The signal controller 600 controls the operation of the scan driver 400 and the data driver 500.

In an exemplary embodiment, each of the scan driver 400, the data driver 500, and the signal controller 600 may be installed directly on the display panel assembly 300 in the form of at least one integrated circuit chip. Alternatively, each of the drivers 400, 500, and 600 may be installed on a flexible printed circuit film (not shown) to be attached to the liquid crystal panel assembly 300 in the form of a tape carrier package (TCP) or installed on a separate printed circuit board (not shown). As a further alternative, one of the scan driver 400 and the data driver 500 may be directly integrated with the display panel assembly 300. In addition, at least two of the scan driver 400, the data driver 500, and the signal controller 600 may be integrated as a single chip.

The operations of the organic light emitting device will now be explained in detail.

In an exemplary embodiment, the signal controller 600 receives input image signals R, G, and B and input control signals for controlling the display of the input image signals R, G, and B from an external graphics controller (not shown). The input image signals R, G, and B may include luminance information of each pixel PX, and luminance includes a determined number of gray levels, e.g., 1024 (=2¹⁰), 256 (=2⁸), or 64 (=2⁶) gray levels. The input control signals may include a vertical synchronization signal Vsync, a horizontal synchronization signal Hsync, a main clock signal MCLK, and a data enable signal DE.

The signal controller 600 processes the input image signals R, G, and B based on the input image signals R, G, and B and the input control signals to generate output image signals DAT, a scan control signal CONT1, a data control signal CONT2, and the like, and thereafter sends the generated scan control signal CONT1 to the scan driver 400 and the generated data control signal CONT2 and the processed image signal DAT to the data driver 500.

The gate control signal CONT1 may include a scan start signal ST for indicating scan start, and at least one clock signal for controlling an output period of the gate-on voltage Von. The gate control signal CONT1 may further include an output enable signal OE for limiting a duration time of the gate-on voltage Von.

The data control signal CONT2 may include a horizontal synchronization start signal STH for indicating initiation of data transmission of the digital image signal DAT for a row of pixels PX, a load signal LOAD for requesting to apply data signals to the data lines D₁ to Dₘ, and a data clock signal HCLK.

In an exemplary embodiment, the data driver 500 may receive digital image signals DAT for a row of pixels PX according to the data control signal CONT2 transmitted from the signal controller 600, and select a grayscale voltage corresponding to each digital image signal DAT to convert the digital image signals DAT into analog data signals. Thereafter, the data driver 500 may apply the converted analog data signals to corresponding data lines D₁ to Dₘ.

The scan driver 400 applies a gate-on voltage Von to the gate lines G₁ to Gₙ according to the scan control signal CONT1 transmitted from the signal controller 600 to turn on the switching transistor Qs connected to the scanning lines G₁ to Gₙ. Then, the data signals applied to the data lines D₁ to Dₘ are applied to the control terminal of the driving transistor Qd through the turned-on switching devices Qs.

The driving transistor Qd, the data voltage having been applied, may be turned on and may output an output current lld having a value that depends on the data voltage. This current lld may flow in the organic light emitting diode LD such that the corresponding pixels PX display images. On the other hand, the data voltage applied to the driving transistor Qd may be charged to the capacitor Cst and the charged voltage maintained after the switching transistor Qs is turned off.

By repeating this procedure by a unit of a horizontal period (also referred to as “1H” and that is equal to one period of the horizontal synchronization signal Hsync and the data enable signal DE), all scanning signal lines G₁-Gₙ may be sequentially supplied with the high voltage Von, thereby applying the data signals to all pixels PX to display an image for a frame. The same operation may be repeated in the next frame.

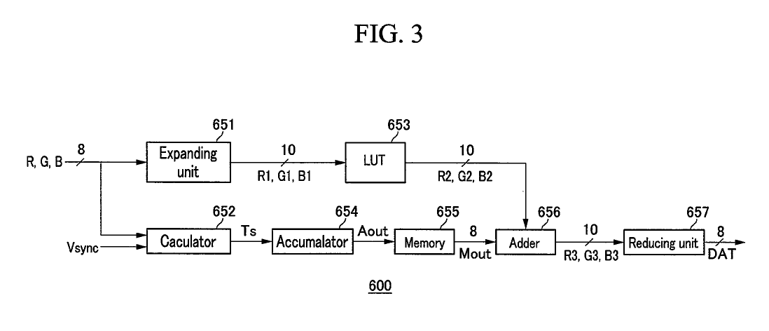

Next, an exemplary embodiment of a driving apparatus for an organic light emitting device will be described in detail with reference to FIG. 3 to FIG. 6.

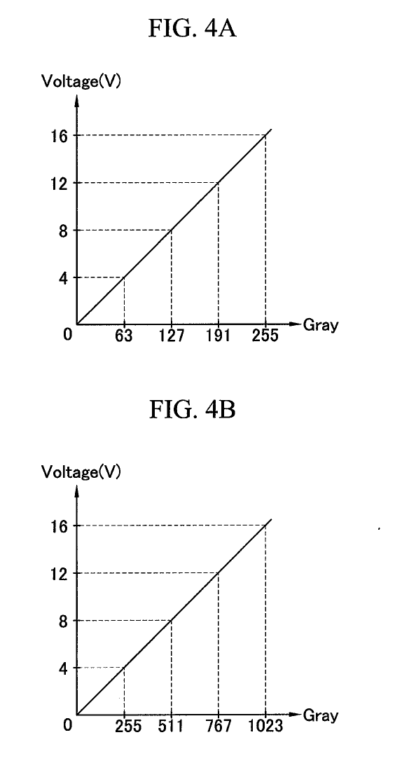

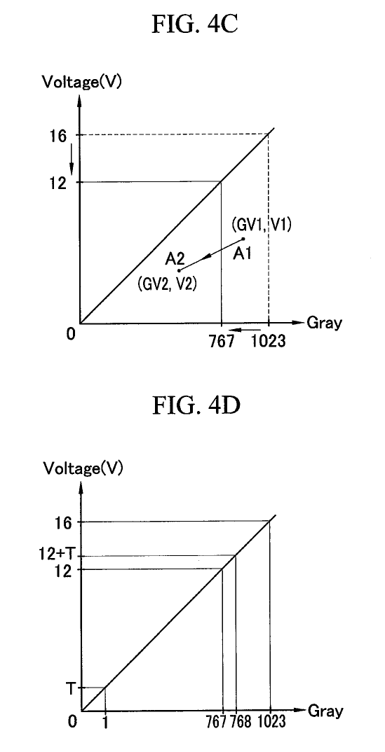

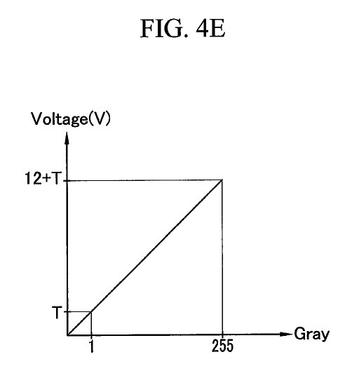

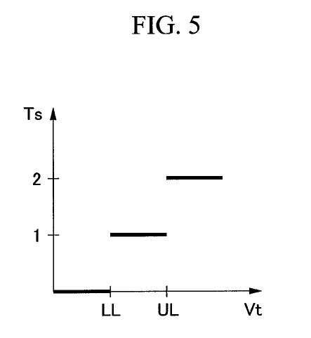

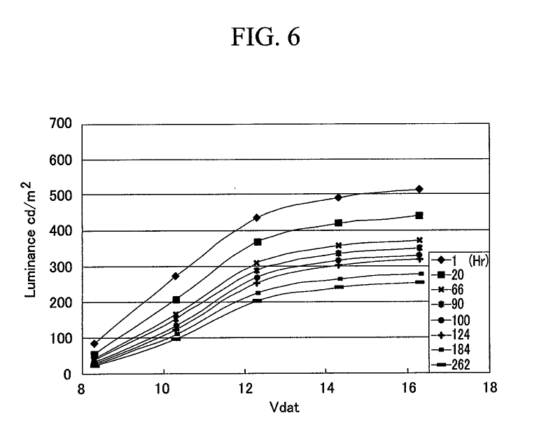

FIG. 3 is a block diagram of an exemplary embodiment of the signal controller shown in FIG. 1. FIG. 4A to FIG. 4E and FIG. 5 are graphs illustrating the operation of the signal controller shown in FIG. 3, and FIG. 6 is a graph illustrating luminance according to time in a conventional organic light emitting device.

In an exemplary embodiment, image signals of 8 bits may be input, and accordingly the luminance of each pixel may be 256=2⁸ grays. Also, in an exemplary embodiment, the highest gray of the input image signals has a voltage of 16V.

Referring to FIG. 3, in an exemplary embodiment, a signal controller of an organic light emitting device may include an expansion unit 651, a calculator 652, an accumulator 654, a lookup table (LUT) 653, a memory 655, an adder 656, and a reduction unit 657.

The expansion unit 651 may expand the input image signals R, G, and B of 8 bits into image signals R1, G1, and B1 of 10 bits to output them to the LUT 653.

The image signals R, G, and B of 8 bits that are input to the signal controller may have 256 grays from 0 gray to 255 gray as in the graph of gray versus voltage shown in FIG. 4A, and have a voltage in a range of 0V to 16V. Similarly, as shown in FIG. 4B, the expanded image signals R1, G1, and B1 of 10 bits may also have assigned values in the range of 0V to 16V, and since they have 1024 grays which is an increase of four times, the expanded image signals R1, G1, and B1 of 10 bits also have the more subdivided values than the voltages of the image signals R, G, and B of 8 bits by four times.

On the other hand, in an exemplary embodiment, the graphs of the grays versus the voltage shown in FIG. 4A to FIG. 4E are all straight lines having an inclination, and these straight lines mean a linear function such that it may be advantageous to realize a logic circuit or to easily calculate.

As shown in FIG. 4C, the LUT 653 may compress the grays and the voltages of the expanded image signals R1, G1, and B1 to three quarters to change into image signals R2, G2, and B2 of 10 bits of the range from 0V to 12V with 768 grays, and output them. For example, if the voltage corresponding to a 1023 gray which is the highest gray among the 1024 grays of the expanded image signal R1, G1, and B1 of 10 bits is 16V, it means that the voltage corresponding to the 767 gray which is the highest gray among the 768 grays of the compressed image signals R2, G2, and B2 of 10 bits is 12V. That is to say, it means that the coordinates GV1 and V1 of the point A1 are transferred to the coordinates GV2 and V2 of the point A2, and this compression may be made by a method in which one among four grays is omitted.

On the other hand, the calculator 652 may be operated by the unit of one frame in the synchronization of the vertical synchronization signal Vsync, and the voltage of the input image signals R, G, and B of 8 bits corresponding to the amount of one frame is calculated. This voltage calculation entails adding the voltages corresponding to the 256 grays of the image signals R, G, and B of 8 bits, as above-described.

Here, for example, as shown in FIG. 5, the uniform result value Ts is output according to the voltage values Vt that are all added, and the result value Ts is changed according to the position where the value Vt is located. For example, the lower value LL and the upper value UL are determined, and if the voltage value Vt is less than the lower value LL, the result value Ts is 0, if the voltage value Vt is between the lower value LL and the upper value UL, the result value Ts is 1, and if the voltage value Vt is more than the upper value UL, the result value Ts is 2.

It may be desirable that the lower value LL and the upper value UL are determined with reference to the voltage when the input image signals R, G, and B of 8 bits all have the highest gray such that the screen displays white color. For example, the upper value UL may be in a range of 20-25% of the voltage when white is displayed, and the lower value LL may be in a range of 10% of the voltage when white is displayed.

In an exemplary embodiment, the accumulator 654 adds up the values from the calculator 652, and when the sum exceeds a predetermined value, an output signal Aout is generated.

In an exemplary embodiment, the memory 655 is a non-volatile memory of 8 bits initially having a 0 value, and it increases by 1 bit according to the output signal Aout and then the increased value Mout is output to the adder 656.

The adder 656 may add the compressed image signals R2, G2, and B2 of 10 bits from the LUT 653 and the output value Mout from the memory 655. Here, for example, the adder 656 adds the output value Mout to the lower 8 bits of the image signal R2, G2, and B2 of 10 bits but does not change the upper 2 bits among the 10 bits.

It is assumed that the output value Mout is “00000001” of which 1 bit is increased compared with the initial value of the memory 655. Thus, this value is added to the lower 8 bits of the image signals R2, G2, and B2 of 10 bits in the adder 656. That is to say, the image signals R2, G2, and B2 of 10 bits are “10111111111” (767 gray), and if the output value Mout is added, the result becomes “1100000000” (768 gray).

Referring to FIG. 4D, 8 bits (the number of 256 grays) stored in the memory 655 are assigned to the 4V remaining after compression, and accordingly, 4/256(=T) V is assigned per 1 gray. Also, because the memory is 8 bits, if 1 bit is added in the memory 655, 1 gray is increased and the voltage is increased by T V. Similarly, because 12V is divided from the 0 gray to 767 gray, T V is assigned per 1 gray. Accordingly, the 768 gray of which 1 gray is added from the 767 gray has a voltage of (12+T) V. Further, 4 V may be increased through 256 times.

On the other hand, the predetermined value may be determined considering the lifetime of the organic light emitting diode LD in the accumulator 654. For example, when the general lifetime of the organic light emitting diode LD is 20,000 hours, an approximate increasing period of 40,000/256 may be determined to increase the life time of 40,000 hours by two times.

The reduction unit 657 reduces the image signals R3, G3, and B3 of 10 bits from the adder 656 to the image signal DAT of 8 bits and outputs them to the data driver 500.

Referring to FIG. 4E, this reduction is to reduce the number of grays by a third with the same voltage range as the image signals R3, G3, and B3 of 10 bits. That is to say, the previous voltage range as above-described is maintained, and as an opposite concept to the expanding of the number of grays, 256 grays (which is a third of all 768 grays) are extracted. However, it is preferable that this extraction is executed with a uniform interval in 768 grays from the 1 gray to the 768 gray excepting the 0 gray of the lowest gray by considering the increased 1 gray.

The example in which the image signal DAT is extracted from the image signals R3, G3, and B3 is represented by Table 1, and the gray values and the voltage values of the corresponding signal are represented.

TABLE 1

| R3, G3, B3 | voltage(V) | DAT |
|---|---|---|
| 0 | 0 | |
| 1 | T | 0 |
| 2 | 2T | |
| 3 | 3T | |
| 4 | 4T | 1 |
| 5 | 5T | |
| 6 | 6T | |
| 7 | 7T | 2 |
| 8 | 8T | |
| 9 | 9T | |
| 10 | 10T | 3 |
| . . . | . . . | . . . |
| 764 | 12 − 2T | 254 |
| 765 | 12 − T | |
| 767 | 12 | |
| 768 | 12 + T | 255 |

Similarly, if 1 bit is again added, the extraction is executed with the uniform interval in the 768 grays from the 2 gray to the 769 gray excepting the 1 gray of the lowest gray. Of course, if it is not increased, the lowest gray is included under extracting.

In this way, the extracted image signals DAT from the reduction unit 657 may be transmitted to the data driver 500, and the data driver 500 selects the voltages corresponding to the image signals DAT, that is to say, the voltages (T, 4T, 7T, . . . , 12+T) of the Table, as the data voltage Vdat to apply to the pixel PX.

On the other hand, as above-described, the operation of the signal controller 600 may gradually increase the control voltage of the driving transistor Qd, that is, the data voltage Vdat.

lld=k(Vgs−Vth)², Vgs=Vdat−Vld (Equation 1)

That is to say, the output voltage Vld of the driving transistor Qd may be decreased such that the current lld that follows in the organic light emitting diode LD is decreased, and accordingly as shown in FIG. 6, when the luminance is decreased according to the passage of time, the data voltage Vdat is increased to uniformly maintain the current lld.

On the other hand, in the exemplary embodiment, the maximum data voltage Vdat may be 12V at the initial time of the driving, and is increased by TV and is increased up to 16V. Here, the voltage corresponding to the highest gray of the input image signals R, G, and B is adjusted to 16V, and the voltage corresponding to the highest gray is decreased to 12V through the compression. Accordingly, the luminance may be decreased, but this may be controlled the same amount by the current flowing under 16V by controlling the driving voltage Vdd and the common voltage Vss. For example, in the case of a 14-inch organic light emitting device, when the maximum data voltage Vdat is 16V, the driving voltage Vdd and the common voltage Vss are respectively 10V and 0V, but when the maximum data voltage Vdat is 12V, the driving voltage Vdd and the common voltage Vss are respectively 10.5V and −1.5V.

Here, the maximum data voltage may be determined by the voltage supplied to a digital-analog converter (not shown) included to the data driver 500, and this voltage is supplied from a DC/DC converter (not shown). The maximum voltage that the DC/DC converter can output may be, for example, 16V, and because this voltage may be used as it is, an additional cost for the DC/DC converter may be reduced. In other words, the maximum data voltage Vdat supplied may be more than 16V, but because a burden of cost accompanies this, it is preferable that the present voltage range is used.

However, if the cost is low enough, a DC/DC converter that can supply a voltage of more than 16V may be used, and it may not be necessary for the driving voltage Vdd and the common voltage Vss to be controlled in this case.

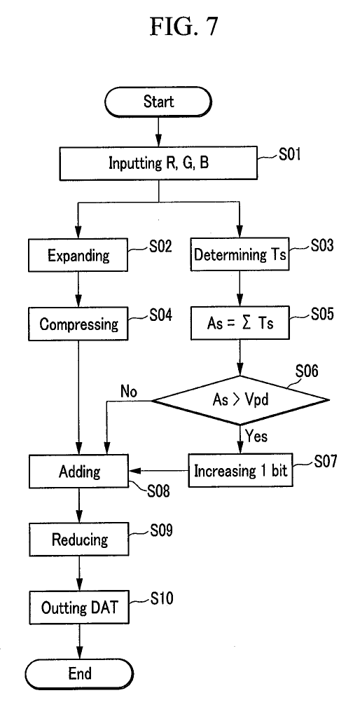

Now, an exemplary embodiment of a driving method of an organic light emitting device will be described with reference to FIG. 7, and the operation of the signal controller 600 shown in FIG. 3 is summarized.

Firstly, if image signals of 8 bits having 256 grays are input (step S01), they may be expanded, for example, to image signals R1, G1, and B1 of 10 bits having 1024 grays in the expansion unit 651 (step S02). Next, they may be compressed, for example, into image signals R2, G2, and B2 of 10 bits having 768 grays through the LUT 653 (step S04).

On the other hand, the voltages corresponding to the grays included in the image signals R, G, and B of 8 bits may all be added in a calculator 652 such that the result values Ts are determined (step S03).

The accumulator 654 may add all the result values Ts to generate a sum As (step S05), it is determined whether the sum As exceeds the predetermined value Vpd (step S06), and when the sum As exceeds the predetermined value Vpd, the output signal Aout is output and is increased by 1 bit through the memory 655 (step S07). When the sum As does not exceed the predetermined value Vpd, the signal is not generated.

The adder 656 adds the image signals R2, G2, and B2 from the LUT 653 and the value from the memory 655 (step S08).

The reduction unit 657 reduces the image signals R3, G3, and B3 from the adder 656 into the image signals DAT of 8 bits (S09) and outputs them to the data driver 500 (step S10).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving apparatus for an organic light emitting device having pixels with light-emitting devices, wherein uniform values based on voltages for each frame corresponding to grays of input image signals are calculated and summed, and data voltages are increased when the sum exceeds a predetermined value.

2. The driving apparatus of claim 1, comprising:
an expansion unit receiving first image signals and expanding the number of grays of first image signals to output second image signals;
a compression unit compressing the number of grays of the second image signals and the corresponding voltages to generate third image signals;
a calculator calculating the voltages corresponding to the grays of the first image signal to calculate uniform values;
an accumulator summing the uniform values to generate a sum;
a memory sequentially increasing bits according to the output signals from the accumulator;
an adder adding the third image signals from the compression unit and the signals from the memory to generate fourth image signals; and
a reduction unit reducing the number of grays of the fourth image signals to generate fifth image signals.

3. The driving apparatus of claim 2, wherein
the expansion unit and reduction unit execute the expansion and reduction while maintaining the previous voltage.

4. The driving apparatus of claim 3, wherein
the calculator adds all the voltages corresponding to one frame, and outputs uniform values according to a lower value and an upper value for the added voltage values.

5. The driving apparatus of claim 4, wherein
the accumulator generates a sum of the uniform values to generate a sum, and outputs an output signal when the sum exceeds the predetermined value.

6. The driving apparatus of claim 5, wherein
the grays of the first and second image signals have a voltage of a predetermined range, the voltage range of the grays of the third image signals is less than the voltage range of the grays of the first and second image signals, and the grays of the fourth and fifth image signals are equal to or more than the voltage range of the grays of the third image signals.

7. The driving apparatus of claim 6, wherein
the grays of the first to fifth image signals and the corresponding voltages are determined as a linear function.

8. The driving apparatus of claim 7, wherein
the memory is a non-volatile memory.

9. The driving apparatus of claim 8, wherein:
when the number of bits of the memory is increased by 1 bit, the fourth and fifth image signals are increased by a voltage determined by dividing the voltage range of the grays of the third image signals by the number of compressed grays.

10. The driving apparatus of claim 9, wherein
the reduction unit extracts grays among the grays of the fourth image signals with uniform intervals to generate the fifth image signals.

11. The driving apparatus of claim 9, wherein
when the number of bits of the memory is increased by 1 bit, the reduction unit extracts grays with uniform intervals among the remaining grays except for the lowest gray among the grays of the fourth image signal to generate the fifth image signals.

12. The driving apparatus of claim 9, further comprising
a data driver receiving the fifth image signals and selecting a voltage corresponding to the grays of the fifth image signals as the data voltage to apply to data lines.

13. A driving method of an organic light emitting device having pixels with a light-emitting device, comprising:
calculating uniform values based on voltages for each frame corresponding to grays of first image signals;
generating a sum of the uniform values;
expanding the number of grays of the first image signals to generate second image signals;
reducing the number of grays of the second image signals along with compression of the corresponding voltages to generate the third image signals;
sequentially increasing bits according to a predetermined output signal;
adding the third image signals and the increased bits to generate fourth image signals; and
reducing the number of grays of the fourth image signals to generate fifth image signals.

14. The driving method of claim 13, wherein the expanding of the number of grays of the first image signals to generate second image signals and the reducing of the number of grays of the fourth image signals to generate fifth image signals are executed while maintaining the previous voltage.

15. The driving method of claim 14, wherein
the calculating of the uniform values based on voltages for each frame corresponding to grays of first image signals includes adding the voltages for each frame and outputting the uniform values according to a lower value and an upper value for the added values.

16. The driving method of claim 15, wherein
the adding up of the uniform values includes outputting an output signal when the sum exceeds the predetermined value.

17. The driving method of claim 16, wherein
the grays of the first and second image signals have the voltage of the predetermined voltage range, the voltage range of the grays of the third image signal is less than the voltage range of the grays of the first and second image signals, and the voltage range of the grays of the fourth and fifth image signals is equal to or more than the voltage range of the grays of the third image signal.

18. The driving method of claim 17, wherein
the grays and the corresponding voltages of the first to fifth image signals are determined by a linear function.

19. The driving method of claim 18, wherein
when the bits are sequentially increased according to the predetermined output signal, the voltages of the fourth and fifth image signals are increased by a value determined by dividing the voltage range of the grays of the third image signal by the number of compressed grays.

20. The driving method of claim 19, wherein
the reducing of the number of grays of the fourth image signals to generate fifth image signals includes extracting the grays among the grays of the fourth image signals with the same interval to generate the fifth image signals.

21. The driving method of claim 19, wherein
the reducing of the number of grays of the fourth image signals to generate fifth image signals includes extracting grays with the same interval among the grays of the fourth image signals except for the lowest gray to generate the fifth image signals when the number of bits is sequentially increased.

22. The driving method of claim 20, further comprising:
receiving the fifth image signals and selecting a voltage corresponding to the grays of the fifth image signals as the data voltage to apply to the pixels.
